(19) United States
(12) Patent Application Publication
(10) Pub. No.: US 2026/0056428 A1
(43) Pub. Date: Feb. 26, 2026

(54) DISPLAY DEVICE

(71) Applicant: Japan Display Inc., Tokyo (JP)

(72) Inventors: Yoshio MARUOKA, Tokyo (JP); Kentaro OKUYAMA, Tokyo (JP); Koji KITAMURA, Tokyo (JP)

(73) Assignee: Japan Display Inc., Tokyo (JP)

(21) Appl. No.: 19/304,626

(22) Filed: Aug. 20, 2025

(30) Foreign Application Priority Data
Aug. 21, 2024 (JP) 2024-139760

(51) Int. Cl. G02F 1/1333; G02F 1/1335

(52) U.S. Cl. CPC G02F 1/133382; G02F 1/133357; G02F 1/133512

(57) ABSTRACT

A display device including a first substrate, a second substrate facing the first substrate, a liquid crystal layer provided between the first substrate and the second substrate, a light source unit provided outside a region where the liquid crystal layer is provided, in plan view, and a heater line, in which the heater line has a first position and a second position, in which a distance from the first position to the light source unit is smaller than a distance from the second position to the light source unit, and in which a cross-sectional area perpendicular to a longitudinal direction of the heater line at the first position is larger than a cross-sectional area perpendicular to the longitudinal direction of the heater line at the second position.

### CROSS-REFERENCE TO RELATED APPLICATION

The present application claims priority to Japanese Patent Application No. 2024-139760 filed on Aug. 21, 2024, the disclosure of which is incorporated herein by reference.

### BACKGROUND

The present invention relates to a display device.

Japanese Unexamined Patent Application Publication No. 2006-47455 (Patent Document 1) discloses a liquid crystal display device for vehicles including a liquid crystal panel and a transparent planar heater in which a transparent conductive film for generating heat is formed on one side of a transparent planar substrate. Japanese Unexamined Patent Application Publication No. 2023-167697 (Patent Document 2) discloses a display device including an array substrate including a display area in which pixels are arranged and a peripheral area outside the display area.

### SUMMARY

However, as the ambient temperature decreases, the fall response speed of the liquid crystal decreases, leading to a problem of degradation in the performance of the display device. Therefore, an object is to improve the performance of the display device.

Other objects and novel features will become apparent from the description of this specification and the accompanying drawings.

A display device including a first substrate, a second substrate facing the first substrate, a liquid crystal layer provided between the first substrate and the second substrate, a light source unit provided outside a region where the liquid crystal layer is provided, in plan view, and a heater line, in which the heater line has a first position and a second position, in which a distance from the first position to the light source unit is smaller than a distance from the second position to the light source unit, and in which a cross-sectional area perpendicular to a longitudinal direction of the heater line at the first position is larger than a cross-sectional area perpendicular to the longitudinal direction of the heater line at the second position.

### BRIEF DESCRIPTION OF THE DRAWINGS

FIG. 1 is an explanatory diagram illustrating a positional relationship in a case where a viewer located on one side of a transparent display panel views a scene on the opposite side through the transparent display panel.

FIG. 2 is an explanatory diagram illustrating an example of a scene visually recognized through a transparent display panel.

FIG. 3 is a perspective view illustrating an example of a display device.

FIG. 4 is a plan view of the display device illustrated in FIG. 3.

FIG. 5 is a cross-sectional view of the display device illustrated in FIG. 4.

FIG. 6 is a circuit block diagram illustrating an example of a circuit included in the display device illustrated in FIG. 3.

FIG. 7 is a plan view of a display device.

FIG. 8 is a plan view of a display device.

### DETAILED DESCRIPTION

Hereinafter, embodiments of the present invention will be described with reference to the drawings. It should be noted that the disclosure is merely an example, and any appropriate modifications that a person skilled in the art can easily conceive while maintaining the gist of the invention are naturally included within the scope of the present invention. Moreover, in the drawings, for the sake of clarity, the widths, thicknesses, shapes, and other dimensions of various components may be represented schematically compared to their actual conditions. However, these are merely examples and are not intended to limit the interpretation of the present invention. In addition, in the present specification and each drawing, elements similar to those described above with respect to the previous drawings are given the same reference numerals, and detailed descriptions may be omitted as appropriate.

In the present application, the description of the embodiments will be described in a plurality of sections or the like as necessary for convenience. Unless it is explicitly stated otherwise, these sections are not mutually independent or separate, but rather are parts of a single example, one being a partial detail or a partial or complete variation of the other, regardless of the order in which they are described. In principle, repeated description of similar parts will be omitted. Furthermore, each component in the embodiments is not essential unless otherwise specified, unless there is a theoretical limit to the number, or unless otherwise clearly stated from the context.

Furthermore, in the accompanying drawings, hatching or the like may be omitted even in cross-sectional views if including it would rather make the drawings complicated or if the distinction from a void is sufficiently clear. In this regard, even for a hole that is closed in plan view, a contour line of the background may be omitted if this is evident from the description or the like. Additionally, even in views that are not cross-sectional, hatching or dot patterns may be provided to indicate that a region is not a void, or to clarify the boundary of a region.

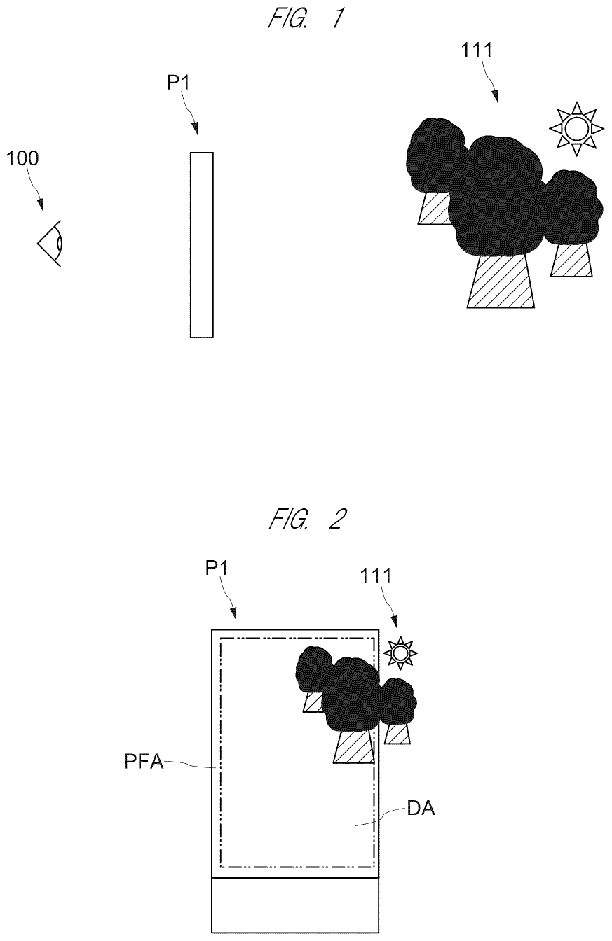

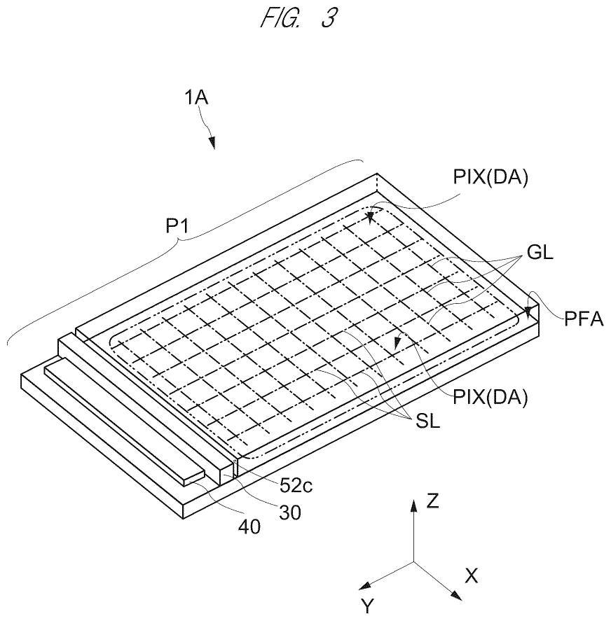

A display device according to a present embodiment will be described. The display device according to the present embodiment includes a transparent display panel. First, the features of the transparent display panel will be described. FIG. 1 is an explanatory diagram illustrating a positional relationship in a case where a viewer located on one side of a transparent display panel views a scene on the opposite side through the transparent display panel. FIG. 2 is an explanatory diagram illustrating an example of a scene visually recognized through a transparent display panel.

As illustrated in FIG. 1, when a viewer 100 looks from one side of a display panel P1 to the other, a scene 111 is visually recognized through the display panel P1. As illustrated in FIG. 2, when a display area DA (PIX) and a peripheral area PFA outside the display area DA both transmit light, the entire scene 111 can be viewed without any discomfort. On the other hand, when the peripheral area PFA has a light-blocking property that does not transmit light, a part of the scene 111 viewed through the display panel P1 is blocked by the peripheral area PFA, which may cause discomfort to the viewer 100. Therefore, in the case of the display panel P1 which is a transparent display panel, it is preferable that each of the display area DA and the peripheral area PFA has visible light transmissivity. Furthermore, from the perspective of allowing the scene 111 to be viewed without discomfort, it is particularly preferable that the visible light transmission characteristics of the display area DA and the peripheral area PFA are approximately the same.

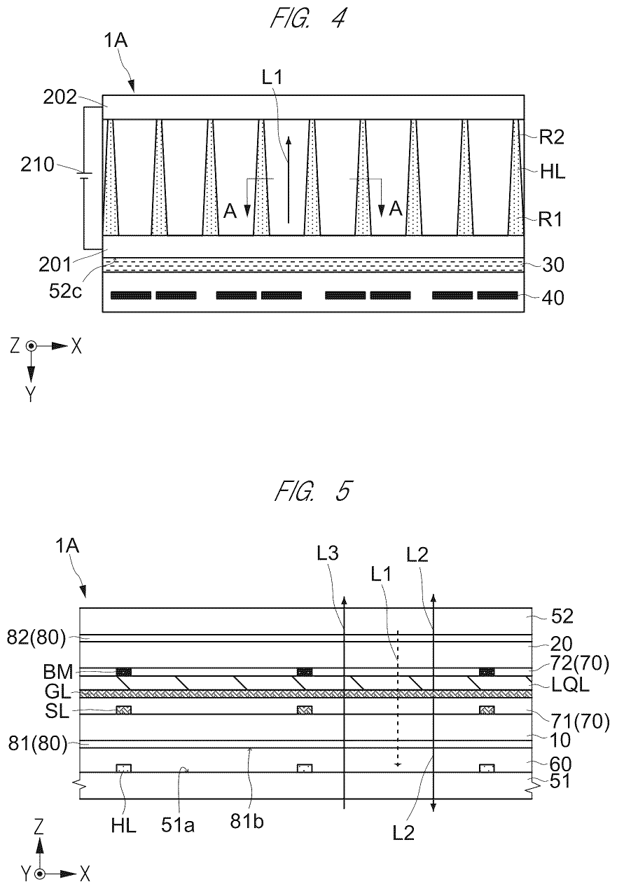

FIG. 3 is a perspective view illustrating an example of a display device. FIG. 4 is a plan view of the display device illustrated in FIG. 3. In FIG. 3, the boundary between the display area DA and the peripheral area PFA is indicated by a two-dot chain line. In addition, in FIG. 3, among the circuits included in the display panel P1, some of the signal lines (more specifically, gate lines GL and source lines SL) that transmit signals for driving the liquid crystal are indicated schematically by one-dot chain lines. In the following drawings including FIG. 3, the direction along the thickness direction of the display panel P1 is referred to as a Z direction, the extension direction of one side of the display panel P1 in the XY plane perpendicular to the Z direction is referred to as an X direction, and the direction intersecting the X direction is referred to as a Y direction. Also, the direction indicated by the arrow indicating the Z-axis direction in the drawings may be referred to as “up”. Furthermore, the direction indicated by the arrow indicating the Z-axis direction in the drawings may be referred to as “down”.

As illustrated in FIGS. 3 and 4, a display device 1A according to the present embodiment includes a display panel P1, a light source unit 30, and a drive circuit 40.

When configured as a display device, in addition to the parts of the display panel P1 illustrated in FIG. 3, for example, a flexible substrate connected to the display panel P1, a housing, and the like may be included. In FIG. 3, parts other than the display panel P1 are not illustrated. Moreover, the display device 1A according to the present embodiment does not require to have a polarizing plate.

The display panel P1 includes a display area DA in which an image is formed in response to an input signal supplied from the outside, and a peripheral area (frame area) PFA surrounding the display area DA. Although the display area DA of the display panel P1 illustrated in FIG. 3 is rectangular, the display area DA may also be a shape other than a rectangle, such as a polygon or a circle. The display area DA is an effective area in which the display panel P1 displays an image, in a plan view of the display surface. In FIG. 3, the display surface is parallel to the XY plane. In the example illustrated in FIG. 3, the light source unit 30 and the drive circuit 40 are each mounted on the display panel P1, but as a modification, a light source substrate (not illustrated) may be attached to the peripheral area PFA of the display panel P1 separately from the display panel P1, and the light source unit 30 may be mounted on the light source substrate (not illustrated).

### Display Panel

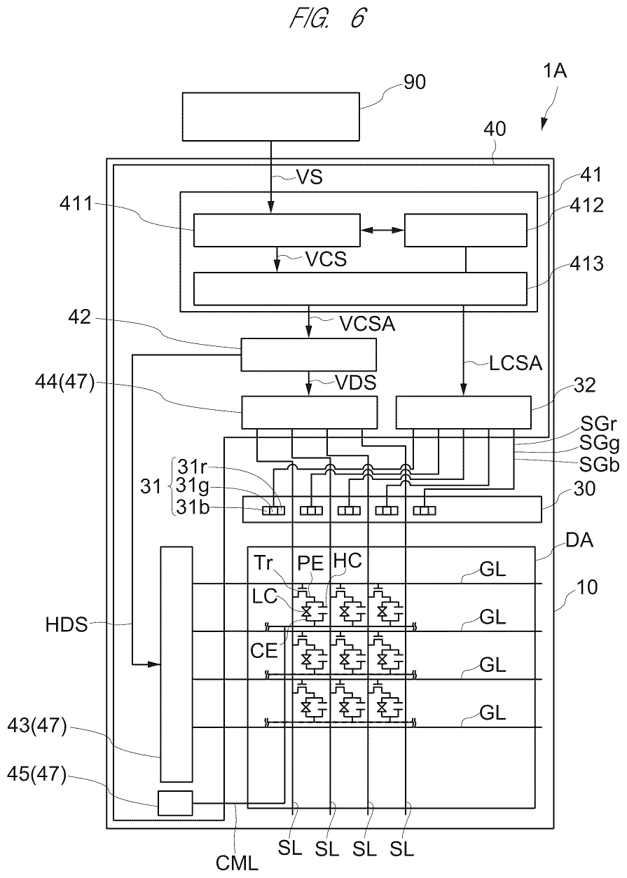

A configuration of the display panel P1 will be described. FIG. 5 is a cross-sectional view of the display device illustrated in FIG. 4. FIG. 5 is a cross-sectional view taken along line A-A of FIG. 4. That is, FIG. 5 is a cross-sectional view of the display panel of the display device illustrated in FIG. 4 taken along a plane perpendicular to the Y direction. FIG. 5 is a cross-sectional view, but hatching of each member other than a liquid crystal layer LQL is omitted.

As illustrated in FIG. 5, the display panel P1 includes an array substrate 10, a counter substrate 20, a front cover substrate 52, a back cover substrate 51, adhesive layers 80, the liquid crystal layer LQL, an alignment film 70, a planarization layer 60, heater lines HL, and light-blocking materials BM.

Although the array substrate 10 can be simply referred to as a substrate, hereinafter it will be described as the array substrate 10, meaning a substrate on which a plurality of switching elements is arranged in an array pattern. As illustrated in FIG. 5, the array substrate 10 has an upper surface and a lower surface opposite to the upper surface. The upper surface and the lower surface of the array substrate 10 are spaced apart from each other. In addition, the array substrate 10 has side surfaces provided between the upper surface and the lower surface. In the present embodiment, the array substrate 10 is a Thin Film Transistor (TFT) substrate. As illustrated in FIG. 5, the array substrate 10 includes the source lines SL and the gate lines. As illustrated in FIG. 5, the source lines SL are provided on the upper surface of the array substrate 10. The source lines SL are in contact with the upper surface of the array substrate 10. The array substrate 10 has visible light transmissivity. The array substrate 10 may be provided with switching elements (active elements) Tr, which will be described later. The thickness of the array substrate 10 is, for example, 0.1 mm or more and 10 mm or less. The source lines SL illustrated in FIG. 5 are lines for transmitting video signals. The gate lines GL are lines for transmitting scanning signals.

In FIG. 4, when the display panel P1 is viewed in plan, light L1 emitted from the light source unit 30 appears to travel along the Y direction. Also, in FIG. 5, when the XZ plane is viewed in plan, the light L1 emitted from the light source unit 30 appears to travel along the Z direction while undergoing repeated total reflection. As illustrated in FIG. 5, the source lines SL are provided along the Y direction. That is, the source lines SL are provided along the traveling direction of the light emitted from the light source unit 30 when the display panel P1 is viewed in plan. As illustrated in FIG. 5, when the display panel P1 is viewed in plan, the gate lines GL are arranged to intersect with the source lines SL. In the present embodiment, the source lines SL and the gate lines GL are perpendicular to each other. The source lines SL and the gate lines GL are spaced apart from one another. The source lines SL are electrically separated from the gate lines GL. Here, “viewing of the display panel P1 in plan view”refers to viewing the XY plane in FIG. 4 in plan view.

As illustrated in FIG. 5, the counter substrate 20 is spaced apart from the array substrate 10. Although the counter substrate 20 can be simply referred to as a substrate, hereinafter it will be described as the counter substrate 20, meaning a substrate disposed at a position opposite to the array substrate 10. The counter substrate 20 has an upper surface and a lower surface opposite to the upper surface. The upper surface and the lower surface of the counter substrate 20 are spaced apart from each other. In addition, the counter substrate 20 has side surfaces provided between the upper surface and the lower surface. As illustrated in FIG. 5, the lower surface of the counter substrate 20 and the upper surface of the array substrate 10 face each other. The counter substrate 20 has visible light transmissivity. The thickness of the counter substrate 20 is, for example, 0.1 mm or more and 10 mm or less.

The counter substrate 20 is bonded to the array substrate 10 via a seal portion (sealing material), for example. The sealing portion (sealing material) bonds the array substrate 10 and the counter substrate 20 together. The sealing portion (sealing material) bonds the array substrate 10 and the counter substrate 20 together. The sealing portion is provided, for example, so as to surround the outer periphery of the liquid crystal layer LQL. The sealing portion, together with the array substrate 10 and the counter substrate 20, surrounds the entire liquid crystal layer LQL. That is, the liquid crystal layer LQL is present inside the seal portion. The sealing portion serves as a seal for enclosing the liquid crystal layer LQL between the array substrate 10 and the counter substrate 20. The seal portion also serves as an adhesive for bonding the array substrate 10 and the counter substrate 20 together.

As illustrated in FIG. 5, the liquid crystal layer LQL is provided between the upper surface of the array substrate 10 and the lower surface of the counter substrate 20. The liquid crystal layer LQL contains liquid crystal LQ. The liquid crystal layer LQL is an optical modulator capable of changing the light transmission state by electrically driving the orientation state of the liquid crystal. The display panel P1 has a function of modulating the light L1 passing through thereof by driving the orientation state of the liquid crystal molecules through control of the electric field generated around the liquid crystal layer LQL via the above-mentioned switching elements.

The liquid crystal LQ is a polymer-dispersed liquid crystal and contains a liquid crystalline polymer and liquid crystal molecules. The liquid crystalline polymer is formed in a fibrous shape, and the liquid crystal molecules are dispersed in the gaps of the liquid crystalline polymer. Each of the liquid crystalline polymer and the liquid crystal molecules has optical anisotropy or refractive index anisotropy. The responsiveness of the liquid crystalline polymer to an electric field is lower than the responsiveness of the liquid crystal molecules to an electric field. The orientation direction of the liquid crystalline polymer hardly changes regardless of the presence or absence of an electric field.

On the other hand, the orientation direction of the liquid crystal molecules changes in response to the electric field when a voltage higher than a threshold value is applied to the liquid crystal LQ. When no voltage is applied to the liquid crystal LQ, the optical axes of the liquid crystalline polymer and the liquid crystal molecules are parallel to each other. Therefore, the light L1 incident on the liquid crystal layer LQL passes through the liquid crystal layer LQL with almost no scattering (transparent state). When a voltage is applied to the liquid crystal LQ, the optical axes of the liquid crystalline polymer and the liquid crystal molecules intersect each other. Therefore, the light L1 incident on the liquid crystal LQ is scattered within the liquid crystal layer LQL (scattering state).

The display panel P1 controls the transparent state and the scattering state by controlling the orientation of the liquid crystal LQ in the propagation path of the light L1. In the scattering state, the light L1 is emitted to the outside of the display panel P1 as emitted light L2 from the upper surface side of the front cover substrate 52 by the liquid crystal LQ. Background light L3 incident from the lower surface side of the back cover substrate 51 is transmitted through the array substrate 10, the liquid crystal layer LQL, the counter substrate 20, the front cover substrate 52, and the like, and is emitted to the outside from the upper surface of the front cover substrate 52. The emitted light L2 and the background light L3 are visually recognized by the viewer on the upper surface side of the front cover substrate 52. The viewer can recognize the emitted light L2 and the background light L3 in combination. Accordingly, the transparent display panel P1 is the display panel P1 that enables the viewer to recognize a display image and a background image superimposed on each other.

As illustrated in FIG. 5, an orientation film 71 is provided between the upper surface of the array substrate 10 and the liquid crystal layer LQL. The orientation film 71 can orientate the liquid crystal molecules of the liquid crystal LQ. The orientation film 71 is in contact with the liquid crystal LQ of the liquid crystal layer LQL.

Light-blocking materials BM are provided on the lower surface of the counter substrate 20. The light-blocking materials BM are provided along the source lines SL. When the display panel P1 is viewed in plan, the positions of the light-blocking materials BM overlap with the positions of the source lines SL. Preferably, when the display panel P1 is viewed in plan, the width of the light-blocking materials BM is greater than the width of the source lines SL. Also preferably, when the display panel P1 is viewed in plan, the source lines SL are disposed within the regions where the light-blocking materials BM are located. The light-blocking materials BM are formed of, for example, a black resin or a metal material. Examples of the metal material include copper, aluminum, chromium, molybdenum, titanium, and Al alloys.

As illustrated in FIG. 5, an orientation film 72 is provided between the lower surface of the counter substrate 20 and the liquid crystal layer LQL. The orientation film 72 can orientate the liquid crystal molecules of the liquid crystal LQ. The orientation film 72 is in contact with the liquid crystal LQ of the liquid crystal layer LQL. Hereinafter, the orientation film 71 and the orientation film 72 may be collectively referred to as an orientation film 70.

As illustrated in FIG. 5, the back cover substrate 51 has an upper surface 51a and a lower surface opposite to the upper surface. Each of the back cover substrate 51 and the front cover substrate 52, which will be described later, can simply be referred to as a substrate; however, in the following description, they are referred to as the back cover substrate 51 and the front cover substrate 52, respectively, to distinguish therebetween. The upper surface and the lower surface are spaced apart from each other. The back cover substrate 51 also has side surfaces provided between the upper surface and the lower surface. In the present embodiment, the back cover substrate 51 is made of glass. In other words, the back cover substrate 51 is a glass substrate made of glass. The back cover substrate 51 has visible light transmissivity. Examples of the material of the back cover substrate 51 include, in addition to glass, organic materials such as acrylic resin or polycarbonate resin. The thickness of the back cover substrate 51 is, for example, 0.5 mm or more to 10 mm or less.

In the present embodiment, the cross-sectional area of the heater line HL at position R1, in a cross section perpendicular to the longitudinal direction thereof, is larger than the cross-sectional area of the heater line HL at position R2 in a cross section perpendicular to the longitudinal direction thereof. Here, the distance between position R1 and the light source unit 30 is smaller than the distance between position R2 and the light source unit 30. Further, as the distance from the light source unit 30 increases, the cross-sectional area of the heater line HL in the cross section perpendicular to the longitudinal direction thereof decreases. In other words, the resistance of the heater line HL at position R1 is smaller than the resistance of the heater line HL at position R2. That is, as the distance from the light source unit 30 increases, the resistance value of the heater line HL increases. Furthermore, as illustrated in FIG. 4, in plan view, the width of the heater line HL at position R1 may be greater than the width of the heater line HL at position R2.

As illustrated in FIG. 4, the heater lines HL are provided along the Y direction. That is, when the display panel P1 is viewed in plan, the heater lines HL are provided parallel to the light incident direction. Here, the light incident direction refers to the direction in which light emitted from the light source unit 30 enters the display panel P1 when viewed in plan. In the example illustrated in FIG. 4, the light incident direction refers to the direction in which light emitted from the light source unit 30 enters the side surface of the front cover substrate 52 when the display panel P1 is viewed in plan. That is, in the example illustrated in FIG. 4, the light incident direction is the Y direction.

As illustrated in FIG. 4, the heater lines HL are electrically connected to a terminal 201 and a terminal 202. The terminal 201 and the terminal 202 are connected to a power supply unit 210. With this configuration, a current flows through the heater lines HL.

As illustrated in FIG. 5, the heater lines HL are provided on the upper surface 51a of the back cover substrate 51. The heater lines HL are in contact with the upper surface 51a of the back cover substrate 51. The heater lines HL contain a metal. For example, the heater lines HL contain an elemental metal or an alloy. Examples of the elemental metal include copper and aluminum. An example of the alloy is an Al alloy (aluminum alloy). The heater lines HL may include not only a single phase but also a plurality of layers. For example, the heater lines HL include a metal wire and a coating layer covering the outer surface of the metal wire.

In the present embodiment, the heater lines HL are provided along the source lines SL. When the display panel P1 is viewed in plan, the positions of the heater lines HL overlap with the positions of the source lines SL.

The heater lines HL are a heater using a resistance heating method. That is, when a current flows through the heater lines HL, the heater lines HL can generate heat. When the display panel P1 is viewed in plan, the width of the heater lines HL is, for example, 0.05 μm or more and 10 μm or less. The thickness of the heater lines HL is preferably 1 μm or more and 5 μm or less. When the thickness of the heater lines HL is 1 μm or more and 5 μm or less, a greater thickness is preferable because it results in lower resistance of the heater lines HL. This allows the current flowing through the heater lines HL to be increased even under the same applied voltage. Therefore, the heating capability of the heater lines HL can be further increased. More preferably, the thickness of the heater lines HL is 0.1 μm or more and 1 μm or less, and even more preferably, 0.3 μm or more and 0.7 μm or less. This makes it less likely that light emitted from the light source unit 30 will be scattered by the heater lines HL.

The planarization layer 60 is provided on the upper surface 51a of the back cover substrate 51. The planarization layer 60 is provided so as to cover the heater lines HL. The planarization layer 60 has an upper surface and a lower surface opposite to the upper surface. The lower surface of the planarization layer 60 is in contact with the back cover substrate 51. Since the planarization layer 60 covers the heater lines HL, the upper surface of the planarization layer 60 and the heater lines HL are spaced apart from each other. In other words, the thickness of the planarization layer 60 is greater than the thickness of the heater lines HL. This makes it possible to protect the heater lines HL. Therefore, it is possible to prevent the heater lines HL containing metal from undergoing a corrosion reaction with, for example, an adhesive layer 81. In addition, when the heater lines HL are provided on the upper surface 51a of the back cover substrate 51, steps are formed. By providing the planarization layer 60 so as to cover the heater lines HL, the steps can be reduced. This makes it easier to bond the back cover substrate 51 having the heater lines HL to another substrate. Preferably, the thickness of the planarization layer 60 is 1 time or more and 10 times or less the thickness of the heater lines HL, and more preferably, 1.5 times or more and 5 times or less. Accordingly, the thickness of the display panel P1 can be reduced.

In the edge-lit type display device 1A, light may pass through the planarization layer 60 a plurality of times. Therefore, it is preferable that the planarization layer 60 is made of a material that absorbs as little light as possible and has low wavelength dispersion. The planarization layer 60 is formed so as to cover a base substrate (for example, the back cover substrate 51) on which a pattern (for example, the heater lines HL) is formed. The planarization layer 60 is an insulating layer made of, for example, an organic insulating material. The planarization layer 60 has a function of planarizing the unevenness caused by the pattern formed on the base substrate. In the example illustrated in FIG. 5, the planarization layer 60 is also referred to as an overcoat layer.

As illustrated in FIG. 5, the adhesive layer 81 is provided between the lower surface of the array substrate 10 and the upper surface of the planarization layer 60. The adhesive layer 81 has an upper surface and a lower surface 81b opposite to the upper surface. The upper surface of the adhesive layer 81 is in contact with the lower surface of the array substrate 10. The lower surface 81b of the adhesive layer 81 is in contact with the upper surface of the planarization layer 60. The adhesive layer 81 serves to bond the array substrate 10 and the planarization layer 60 together. The planarization layer 60 and the back cover substrate 51 are fixed to the array substrate 10 by the adhesive layer 81. The adhesive layer 81 has visible light transmission characteristics. It is preferable that the refractive index of the adhesive layer 81 is closer to the refractive indices of the planarization layer 60 and the array substrate 10 than to that of air. When the refractive index of the adhesive layer 81 is equivalent to those of the planarization layer 60 and the array substrate 10, reflection of light L1 at the interfaces between the upper surface of the planarization layer 60 and the adhesive layer 81, and between the lower surface of the array substrate 10 and the adhesive layer 81, can be suppressed. Examples of the adhesive layer 81 include a transparent adhesive sheet called an Optical Clear Adhesive (OCA) formed in a sheet shape, and an Optical Clear Resin (OCR), which is a liquid transparent adhesive used by curing.

As illustrated in FIG. 5, the front cover substrate 52 has an upper surface and a lower surface opposite to the upper surface. The upper surface and the lower surface are spaced apart from each other. In addition, the front cover substrate 52 has a side surface 52c provided between the upper surface and the lower surface. In the example illustrated in FIGS. 3 and 4, the side surface 52c of the front cover substrate 52 functions as a light incident surface for introducing light into the interior of the front cover substrate 52. The front cover substrate 52 functions as a light guide plate. The side surface 52c of the front cover substrate 52 faces the light source unit 30. In the present embodiment, when the display panel P1 is viewed in plan, light emitted from the light source unit 30 travels along the Y direction as illustrated in FIG. 4.

In the present embodiment, the front cover substrate 52 is made of glass. In other words, the front cover substrate 52 is a glass substrate made of glass. The front cover substrate 52 has visible light transmissivity. Examples of the material of the front cover substrate 52 include, in addition to glass, organic materials such as acrylic resin or polycarbonate resin.

As illustrated in FIG. 5, an adhesive layer 82 is provided between the lower surface of the front cover substrate 52 and the upper surface of the counter substrate 20. The adhesive layer 82 has an upper surface and a lower surface opposite to the upper surface. The upper surface of the adhesive layer 82 is in contact with the lower surface of the front cover substrate 52. The lower surface of the adhesive layer 82 is in contact with the upper surface of the counter substrate 20. The adhesive layer 82 serves to bond the front cover substrate 52 and the counter substrate 20 together. The front cover substrate 52 is fixed to the counter substrate 20 are fixed by the adhesive layer 82. The adhesive layer 82 has visible light transmission characteristics. It is preferable that the refractive index of the adhesive layer 82 is closer to the refractive indices of the front cover substrate 52 and the counter substrate 20 than to that of air. When the refractive index of the adhesive layer 82 is equivalent to those of the front cover substrate 52 and the counter substrate 20, reflection of the light L1 at the interface between the lower surface of the front cover substrate 52 and the adhesive layer 82, and the interface between the upper surface of the counter substrate 20 and the adhesive layer 82, can be suppressed. Examples of the adhesive layer 82 include a transparent adhesive sheet called an Optical Clear Adhesive (OCA) formed in a sheet shape, and an Optical Clear Resin (OCR), which is a liquid transparent adhesive used by curing. Hereinafter, the adhesive layer 81 and the adhesive layer 82 may be collectively referred to as the adhesive layers 80.

Next, the effects of the display device 1A according to the present embodiment will be described. In transparent displays, color image display is generally performed by field-sequential driving using RGB three-color LEDs. As the ambient temperature decreases, the rise response speed of the liquid crystal LQ decreases. As a result, the brightness of the display begins to decrease. Furthermore, as the ambient temperature decreases, the fall response speed of the liquid crystal LQ also decreases. This causes the lighting to continue even during the LED lighting period for the next frame color. Therefore, color mixing occurs, and as the temperature becomes lower, there is a possibility that the displayed image will shift to monochrome.

As countermeasures against the decrease in brightness and the shift to monochrome, it is conceivable to improve the response speed of the liquid crystal LQ. In order to improve the response speed of the liquid crystal LQ, it is necessary to heat the liquid crystal LQ. As a method of heating to improve the decrease in brightness and the shift to monochrome, it is conceivable to raise the temperature using a heater. However, due to the structure of the display device 1A, the side closer to the drive circuit 40 and the light source unit 30 tends to have a higher temperature because of heat generation from the drive circuit 40 and the light source unit 30, whereas the side farther from the drive circuit 40 and the light source unit 30 tends to have a lower temperature depending on the ambient temperature. In other words, there is a tendency for a temperature distribution to occur within the plane of the display device 1A. When heating uniformly within the plane using a heater in a state where a temperature distribution has occurred within the plane of the display device 1A, there is a possibility that when the region with a lower temperature is heated to a predetermined temperature, the region with a higher temperature may be excessively heated. As a result, power consumption may increase.

In the display device 1A according to the present embodiment, the cross-sectional area perpendicular to the longitudinal direction of the heater line HL at position R1 is larger than the cross-sectional area perpendicular to the longitudinal direction of the heater line HL at position R2. In other words, the resistance of the heater line HL at position R1 is smaller than the resistance of the heater line HL at position R2. As a result, when the same current flows through the heater line HL, the amount of heat generated in the heater line HL at position R1 is smaller than the amount of heat generated in the heater line HL at position R2. Consequently, the amount of heat generated in the heater line HL at a position relatively close to the drive circuit 40 and the light source unit 30 can be reduced. In addition, the amount of heat generated in the heater line HL at a position relatively far from the drive circuit 40 and the light source unit 30 can be increased. Therefore, compared to the case where the amount of heat generated within the plane of the heater line HL is uniform, the current value required for temperature rise can be reduced. Thus, the power consumption of the display device 1A can be reduced. Here, the distance between position R1 and the light source unit 30 is smaller than the distance between position R2 and the light source unit 30.

### Configuration Example of Circuit

Next, a configuration example of a circuit included in the display device 1A illustrated in FIG. 4 will be described. FIG. 6 is a circuit block diagram illustrating an example of the circuit included in the display device illustrated in FIG. 4. A wiring path connected to a common electrode CE illustrated in FIG. 6 is formed, for example, on the counter substrate 20 illustrated in FIG. 5. In the example illustrated in FIG. 6, a light source control unit 32 is included in the drive circuit 40. As a modification, the light source control unit 32 may be provided separately from the drive circuit 40. The light source control unit 32 is formed, for example, on a wiring board (illustration omitted) connected to the light source unit 30 illustrated in FIG. 3, and is electrically connected to a light source 31 via the wiring board. The drive circuit 40 is, for example, a driver IC.

In the example illustrated in FIG. 6, the drive circuit 40 includes a signal processing circuit 41, a pixel control circuit 42, and a display panel drive circuit 47. The display panel drive circuit 47 includes a gate drive circuit 43, a source drive circuit 44, and a common potential drive circuit 45. The light source 31 includes, for example, a red light source unit 31r, a green light source unit 31g, and a blue light source unit 31b. By making the area of the array substrate 10 larger than the area of the counter substrate 20, the drive circuit 40 and the light source unit 30 can be provided on the array substrate 10.

The signal processing circuit 41 includes an input signal analysis unit (input signal analysis circuit) 411, a storage (storage circuit) 412, and a signal adjustment unit 413. The display panel P1 has a control unit 90 that includes a control circuit that controls the display of an image. An input signal VS is input to the input signal analysis unit 411 of the signal processing circuit 41 from the control unit 90 via a wiring path such as a flexible wiring board (not illustrated). The input signal analysis unit 411 performs analysis processing based on the input signal VS received from the outside and generates an input signal VCS. The input signal VCS is, for example, a signal that determines what gradation value is given to each pixel PIX (see FIG. 3) of the display panel P1 (see FIG. 3) based on the input signal VS.

The signal adjustment unit 413 generates an input signal VCSA from the input signal VCS input from the input signal analysis unit 411. The signal adjustment unit 413 sends the input signal VCSA to the pixel control circuit 42 and sends a light source control signal LCSA to the light source control unit 32. The light source control signal LCSA is a signal including information on the light quantity of the light source 31, which is set according to an input gradation value for each pixel PIX. For example, when a dark image is displayed, the light quantity of the light source 31 is set to a low level. When a bright image is displayed, the light quantity of the light source 31 is set to a high level.

The pixel control circuit 42 generates a horizontal drive signal HDS and a vertical drive signal VDS based on the input signal VCSA. For example, in the present embodiment, since driving is performed using a field sequential method, the horizontal drive signal HDS and the vertical drive signal VDS are generated for each color that the light source 31 can emit. The gate drive circuit 43 sequentially selects the gate lines GL of the display panel P1 (see FIG. 3) within one vertical scanning period based on the horizontal drive signal HDS. The order of selecting the gate lines GL is arbitrary. As illustrated in FIG. 3, a plurality of gate lines (signal lines) GL extends in the X direction and is arranged along the Y direction.

The source drive circuit 44 supplies a gradation signal corresponding to an output gradation value of each pixel PIX (see FIG. 3) to each source line SL of the display panel P1 (see FIG. 3) within one horizontal scanning period based on the vertical drive signal VDS. As illustrated in FIG. 3, a plurality of source lines (signal lines) SL extends in the Y direction and is arranged along the X direction. A pixel PIX is formed at each intersection of a gate line GL and a source line SL. At each intersection where the gate line GL and the source line SL cross, a switching element Tr is formed. The plurality of gate lines GL and the plurality of source lines SL correspond to a plurality of signal lines that transmit drive signals for driving the liquid crystal LQ.

As the switching element Tr illustrated in FIG. 6, for example, a thin film transistor (TFT) is used. The type of thin film transistor is not particularly limited, and examples include the following. Classified by the position of the gate, there are bottom-gate transistors and top-gate transistors. Classified by the number of gates, there are single-gate thin film transistors and double-gate thin film transistors. One of the source electrode and the drain electrode of the switching element Tr is connected to the source line SL, and the gate electrode is connected to the gate line GL. The other of the source electrode and the drain electrode is connected to one end of the capacitance of the polymer-dispersed liquid crystal LC. One end of the capacitance of the polymer-dispersed liquid crystal LC is connected to the switching element Tr via a pixel electrode PE, and the other end is connected to a common potential line CML via the common electrode CE. Also, a holding capacitor HC is formed between the pixel electrode PE and a holding capacitor electrode electrically connected to the common potential line CML. The common potential is supplied to the common potential line CML from the common potential drive circuit 45.

### Light Source Unit

A configuration of the light source unit 30 will be described. The light source unit 30 is provided at a position facing the side surface 52c of the front cover substrate 52 (see FIGS. 3 and 4). Although not particularly limited, the light source unit 30 includes, for example, the light source 31 and a lens. The light source 31 includes, for example, a red light source unit 31r, a green light source unit 31g, and a blue light source unit 31b. The red light source unit 31r, the green light source unit 31g, and the blue light source unit 31b are each composed of a plurality of light-emitting diode elements, for example. The lens is disposed, for example, between the side surface of the front cover substrate 52 illustrated in FIG. 4 and the plurality of light-emitting diode elements. The plurality of light-emitting diode elements includes light-emitting diode elements capable of emitting light of a first color (e.g. red), light-emitting diode elements capable of emitting light of a second color different from the first color (e.g. green), and light-emitting diode elements capable of emitting light of a third color different from the first color and the second color (e.g. blue). The plurality of light-emitting diode elements is arranged along the X direction so as to align along the side surface of the front cover substrate 52.

In the case of the display device 1A that performs color display, for example, lighting on and off of the light source 31 is controlled. Furthermore, the red light source unit 31r, the green light source unit 31g, and the blue light source unit 31b are caused to emit light at different timings from each other. Specifically, as illustrated in FIG. 6, the light source control unit 32 outputs a signal SGr that controls the lighting on and off of the red light source unit 31r to the red light source unit 31r, outputs a signal SGg that controls the lighting on and off of the green light source unit 31g to the green light source unit 31g, and outputs a signal SGb that controls the lighting on and off of the blue light source unit 31b to the blue light source unit 31b.

When adjusting the white balance of the display device 1A, the luminance of each light-emitting diode element of each RGB color is adjusted based on the chromaticity of each monochromatic color. Specifically, in the white balance adjustment, the current input to and lighting time of each of the red light source unit 31r, the green light source unit 31g, and the blue light source unit 31b are adjusted so as to reduce variations in luminance among the RGB colors.

In the above description, an example in which the light source unit 30 is provided at a position facing the side surface of the front cover substrate 52 has been described. However, the arrangement of the light source unit 30 is not particularly limited and may be provided at a position facing the side surface of the rear cover substrate 51 or at a position facing the side surface of the counter substrate 20.

### Modification

A modification of the display device according to the embodiment will be described. Note that identical components are denoted by the same reference numerals, and the descriptions thereof may be omitted.

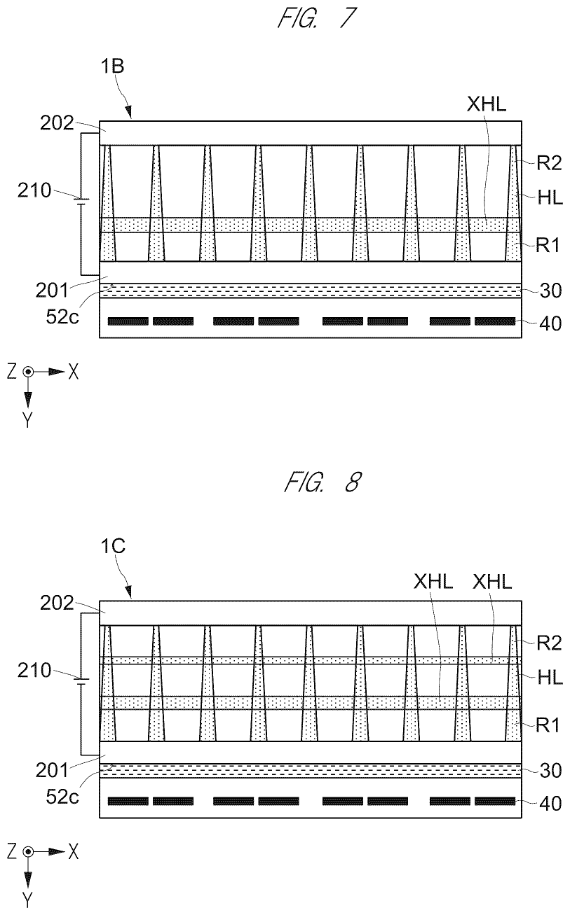

FIG. 7 is a plan view of the display device. As another embodiment, a display device 1B further includes a lateral heater line XHL provided along a direction intersecting the heater lines HL. With this configuration, a decrease in heater function can be prevented even if a part of the heater lines HL or the lateral heater line XHL is disconnected. Further, as illustrated in FIG. 8, two or more lateral heater lines XHL can be provided. When two or more lateral heater lines XHL are provided, it is preferable that the cross-sectional area in the longitudinal direction of the lateral heater lines XHL located relatively closer to the light source unit 30 be larger than that of the lateral heater lines XHL located relatively farther from the light source unit 30. This allows the amount of heat generated in the lateral heater lines XHL located relatively close to the light source unit 30 to be reduced, and the amount of heat generated in the lateral heater lines XHL located relatively far from the light source unit 30 to be increased. As a result, the power consumption of the display device 1C can be further reduced.

In the example illustrated in FIG. 5, three heater lines HL are provided along the three source lines SL. On the other hand, in the other embodiment, for example, while three source lines SL are provided, only two heater lines HL are arranged. That is, the number of heater lines HL is reduced to less than the number of source lines SL. Further, when the display panel P1 is viewed in plan, it is preferable that the plurality of heater lines HL is arranged at equal intervals. With this configuration, even if moire patterns occur due to viewing angle, they will not be noticeable.

It is to be understood that various changes and modifications may be conceived by those skilled in the art within the scope of the spirit of the present invention, and such changes and modifications are also considered to fall within the scope of the present invention. For example, in the above embodiments, additions, deletions, or design changes of components, as well as additions, omissions, or changes of process conditions made as appropriate by those skilled in the art, are also included within the scope of the present invention as long as the essential features of the invention are retained.

Furthermore, other effects and advantages that are apparent from the present specification or that can be conceived by those skilled in the art based on the embodiments described herein shall naturally be regarded as being provided by the present invention.

What is claimed is:

1. A display device comprising:
a first substrate;
a second substrate facing the first substrate;
a liquid crystal layer provided between the first substrate and the second substrate;
a light source unit provided outside a region where the liquid crystal layer is provided, in plan view; and
a heater line,
wherein the heater line has a first position and a second position,
wherein a distance from the first position to the light source unit is smaller than a distance from the second position to the light source unit, and
wherein a cross-sectional area perpendicular to a longitudinal direction of the heater line at the first position is larger than a cross-sectional area perpendicular to the longitudinal direction of the heater line at the second position.

2. The display device according to claim 1,
wherein, in plan view, a width of the heater line at the first position is larger than a width of the heater line at the second position.

3. The display device according to claim 1,
wherein the heater wiring includes:
a plurality of first heater lines extending in a first direction in plan view; and
a second heater line provided along a second direction intersecting the first direction in plan view, and
wherein the second heater line is connected to each of the plurality of first heater lines.

4. The display device according to claim 1, further comprising
a third substrate provided on a side opposite to the second substrate with respect to the first substrate,
wherein the heater line is provided on a surface of the third substrate facing the first substrate.

5. The display device according to claim 1, further comprising:
a third substrate provided on a side opposite to the second substrate with respect to the first substrate; and
a fourth substrate provided on a side opposite to the first substrate with respect to the second substrate,
wherein the heater line is provided on a surface of the third substrate facing the first substrate.

6. The display device according to claim 1, further comprising
a planarization layer provided so as to cover the heater line.

7. The display device according to claim 1, further comprising:
a third substrate provided on a side opposite to the second substrate with respect to the first substrate; and
an adhesive layer provided between the first substrate and the third substrate.

8. The display device according to claim 1, further comprising
a light-blocking layer provided on a surface of the second substrate facing the first substrate,
wherein, in plan view, the light-blocking layer is arranged along the heater line so as to overlap with a position of the heater line.

9. The display device according to claim 1,
wherein the light source unit is provided at a position facing a side surface of the second substrate and is capable of emitting light in a first direction in plan view, and
in plan view, the heater line is provided along the first direction.

10. The display device according to claim 3, further comprising
a third heater line provided along the second direction intersecting the first direction in plan view,
wherein the third heater line is connected to each of the plurality of first heater lines,
wherein a distance from the second heater line to the light source unit is smaller than a distance from the third heater line to the light source unit, and
wherein a cross-sectional area perpendicular to a longitudinal direction of the second heater line is larger than a cross-sectional area perpendicular to a longitudinal direction of the third heater line.
